(19) United States
(12) Patent Application Publication
(10) Pub. No.: US 2015/0347700 A1
(43) Pub. Date: Dec. 3, 2015

(54) CORRELATING BEHAVIORS AND WELLNESS OUTCOMES

(71) Applicant: Microsoft Corporation, Redmond, WA (US)

(72) Inventors: Farah Shariff, Kirkland, WA (US); Dave Wickert, Redmond, WA (US); Fernando Godinez, Sammamish, WA (US)

(21) Appl. No.: 14/291,916

(22) Filed: May 30, 2014

(51) Int. Cl. G06F 19/00; G06F 17/30

(52) U.S. Cl. CPC G06F 19/3418; G06F 17/3087; G06F 17/30997

(57) ABSTRACT

The disclosure provides for a system for correlating user behaviors with wellness outcomes. The system includes a wearable electronic device including a sensor subsystem. The sensor subsystem yields sensor output data spanning multiple days during which the wearable computing device is continuously worn by the user. From the sensor output, behavior(s) and wellness outcome(s) of the user are determined, and a correlation is identified between one or more user behaviors and a wellness outcome. A message based on that correlation is presented on a display associated with the wearable electronic device.

### BRIEF DESCRIPTION OF THE DRAWINGS

FIGS. 1A and 1B depict perspectives of an embodiment of an exemplary wearable electronic device according to the present disclosure.

FIG. 2 schematically depicts an external computing system interfacing with one or more user devices including the wearable electronic device of FIGS. 1A and 1B, in order to generate and provide messaging relating to correlations between user behaviors and wellness outcomes.

FIG. 3 depicts an example method for correlating user behaviors and wellness outcomes, from the perspective of a wearable electronic device having sensors that generate sensor output data which can be used to determine the user behaviors and wellness outcomes.

FIG. 4 depicts an example method for correlating user behaviors and wellness outcomes, from the perspective of a system that generates the correlations based on sensor output data received from a wearable electronic device.

FIG. 5 depicts display of example messages based on correlations between user behaviors and wellness outcomes.

FIG. 6 schematically depicts a form-agnostic sensory and logic system.

### DETAILED DESCRIPTION

A wide variety of portable electronic devices exist for tracking a user's physical activities. Examples of such devices include pedometers; wearable activity trackers; computers associated with exercise equipment (e.g., bicycling computers); and devices that include sensors to detect physical activity. One specific example of a wearable device is an accelerometer- or gyroscope-based movement tracker, for example for counting steps taken by the wearer. While such devices can provide a range of information about the user's activities, they are limited in a variety of ways. Many devices are limited in the behaviors they capture. Many fitness trackers, for example, are limited to calculating steps based on an accelerometer output.

The present disclosure contemplates a system for correlating user behaviors with wellness outcomes. The system includes a wearable electronic device including a sensor subsystem configured to yield sensor output data associated with a user. The sensor output data encompasses and is captured over at least one interval spanning multiple days during which the wearable computing device is continuously worn by the user. The system further includes a display associated with the wearable electronic device, which may be on the wearable electronic device or on an associated device. The wearable electronic device is configured to send the sensor output data to an external computing system. From the sensor output data, the external computing system identifies one or more user behaviors of the user, one or more wellness outcomes of the user, and a behavior/wellness outcome correlation. A message based on the correlation is presented to the user on the display.

A wearable electronic device may be part of a novel system for tracking user behaviors and providing actionable insights about those behaviors and the way that they correlate with wellness outcomes. The wearable electronic device includes a sensor subsystem that may have a variety of different sensors. The sensor subsystem captures data associated with the user, and this data typically is captured over relatively long intervals during which the device is continuously worn by the user, for example spanning multiple days (or weeks, months or longer) and covering a range of activities such walking, running, other exercise, eating, working, relaxing, sleeping, and other activities or behaviors.

The system interprets and analyzes data output from the sensor(s), potentially along with other data such as from the user's calendar or phone/email/text activity, to gain a comprehensive picture of the user. Among other things, this analysis can be in the form of observable correlations between one or more behaviors of the user and a wellness outcome of the user. The system can use these correlation insights to provide helpful messages to the user, for example by providing a diagnosis-type message describing a link between a behavior and the effect it has upon the user's wellness, or by providing a recommendation to the user to engage in a particular behavior that promotes a wellness outcome. More generally, the analysis of sensor output data can yield messaging that diagnoses behavior, identifies trends and patterns, predicts and forecasts outcomes, and provides contextual guidance in order to further the wellness of the user.

An extremely wide variety of messages can be provided to the user. These messages can be based on (1) observed correlations between user behaviors and wellness outcomes, as determined from the sensor output data; (2) other information captured about the user and/or other users; and/or (3) non-user information, such as from wellness-related articles or studies and other lifestyle media.

Messaging may take various formats, but in some cases it will be helpful to personify the communications, for example as if spoken by a coach or mentor. Examples include: (1) “I've noticed that you sleep better when you've exercised in the morning, as opposed to exercising in the evening.” (2) “It takes you longer to fall asleep when you do high-intensity exercise in the evening.” (3) “You have a lot of meetings on your calendar tomorrow—perhaps you should get to bed a little earlier tonight and exercise first thing tomorrow.” (4) You've gained extra weight lately. You had stable calorie intake but you haven't been exercising as much.” (5) “Your hours of sleep have been declining Being short on sleep leads to craving high-fat foods.” This message could be accompanied by a sleep pattern graph and an article abstract about the link between sleep and food cravings. (6) “Log and lose. People who consistently log their daily food and drink lose 50% more weight than those who don't.” This message could be accompanied by a supporting info graphic.

In some examples, the described systems and methods are contextual, in the sense that messages can be timed to occur at particularly relevant moments for the user. For example, the system might learn over time that certain actions correlate positively with wellness outcomes. Then, in response to detecting a temporal opportunity to engage in one of the actions, the system prompts the user with a message to take the action. For example: “It's 10:30 pm and you've gotten less sleep than usual this week.” Or: “Your heart rate and sleep patterns show that you are very well-rested. Today or tomorrow would be a great day for a high-intensity interval workout.”

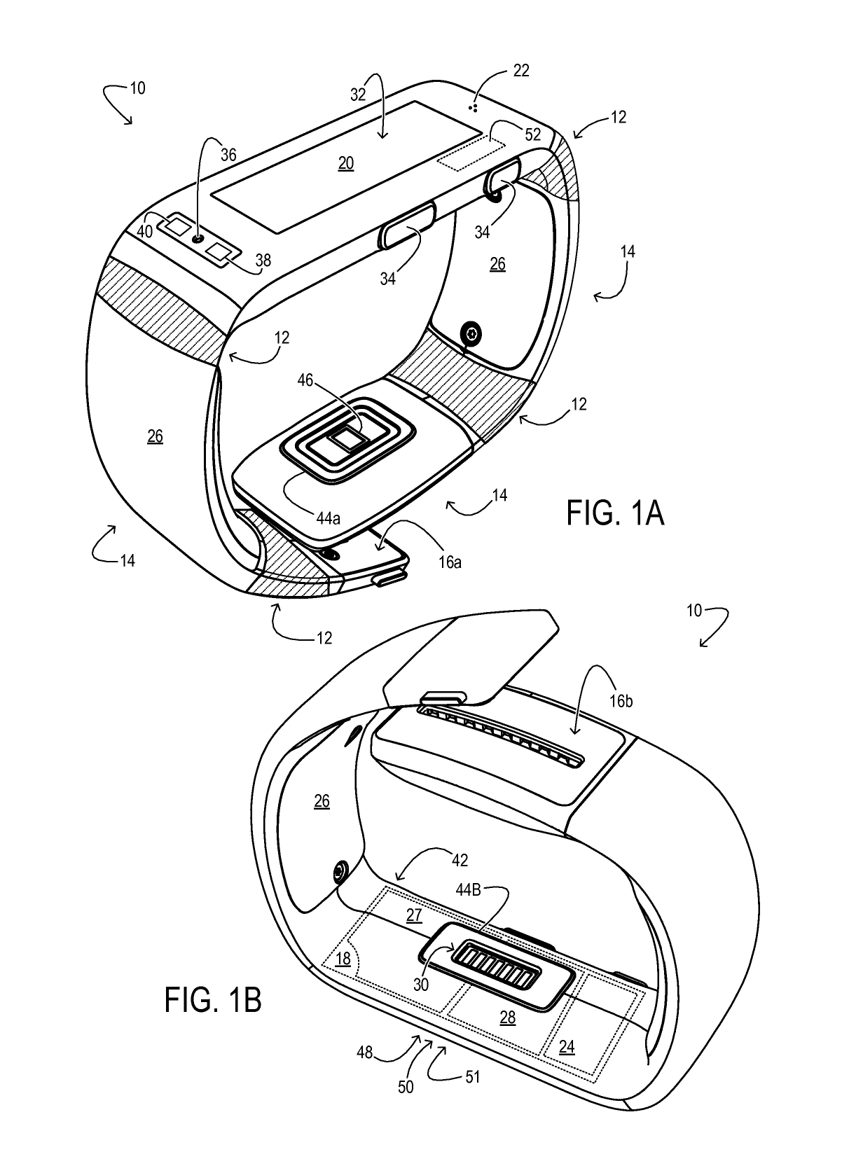

Turning now to the figures, FIGS. 1A and 1B show aspects of an example sensory-and-logic system in the form of a wearable electronic device 10. The illustrated device is band-shaped and may be worn around a wrist. Device 10 includes at least four flexion regions 12 linking less flexible regions 14. The flexion regions of device 10 may be elastomeric in some examples. Fastening componentry 16A and 16B is arranged at both ends of the device. The flexion regions and fastening componentry enable the device to be closed into a loop and to be worn on a user's wrist. In other implementations, wearable electronic devices of a more elongate band shape may be worn around the user's bicep, waist, chest, ankle, leg, head, or other body part. The device, for example, may take the form of eye glasses, a head band, an arm-band, an ankle band, a chest strap, or an implantable device to be implanted in tissue.

Wearable electronic device 10 includes various functional components integrated into regions 14. In particular, the electronic device includes a compute system 18, display 20, loudspeaker 22, communication suite 24, and a sensor subsystem with various sensors. These components draw power from one or more energy-storage cells 26. A battery—e.g., a lithium ion battery—is one type of energy-storage cell suitable for this purpose. Examples of alternative energy-storage cells include super- and ultra-capacitors. In devices worn on the user's wrist, the energy-storage cells may be curved to fit the wrist, as shown in the drawings.

In general, energy-storage cells 26 may be replaceable and/or rechargeable. In some examples, recharge power may be provided through a universal serial bus (USB) port 30, which includes a magnetic latch to releasably secure a complementary USB connector. In other examples, the energy storage cells may be recharged by wireless inductive or ambient-light charging. In still other examples, the wearable electronic device may include electro-mechanical componentry to recharge the energy storage cells from the user's adventitious or purposeful body motion. For example, batteries or capacitors may be charged via an electromechanical generator integrated into device 10. The generator may be turned by a mechanical armature that turns while the user is moving and wearing device 10.

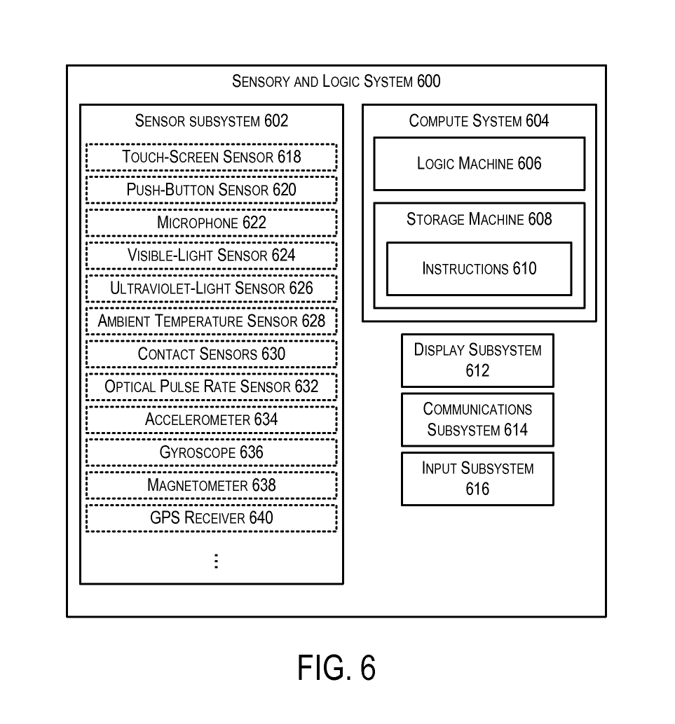

In wearable electronic device 10, compute system 18 is situated below display 20 and operatively coupled to the display, along with loudspeaker 22, communication suite 24, and the various sensors. The compute system includes a data-storage machine 27 to hold data and instructions, and a logic machine 28 to execute the instructions. Aspects of the compute system are described in further detail with reference to FIG. 6.

Display 20 may be any suitable type of display. In some configurations, a thin, low-power light emitting diode (LED) array or a liquid-crystal display (LCD) array may be used. An LCD array may be backlit in some implementations. In other implementations, a reflective LCD array (e.g., a liquid crystal on silicon, LCOS array) may be frontlit via ambient light. A curved display may also be used. Further, AMOLED displays or quantum dot displays may be used.

Communication suite 24 may include any appropriate wired or wireless communications componentry. In FIGS. 1A and 1B, the communications suite includes USB port 30, which may be used for exchanging data between wearable electronic device 10 and other computer systems, as well as providing recharge power. The communication suite may further include two-way Bluetooth, Wi-Fi, cellular, near-field communication and/or other radios. In some implementations, the communication suite may include an additional transceiver for optical, line-of-sight (e.g., infrared) communication.

In wearable electronic device 10, touch-screen sensor 32 is coupled to display 20 and configured to receive touch input from the user. The touch sensor may be resistive, capacitive, or optically based. Pushbutton sensors may be used to detect the state of push buttons 34, which may include rockers. Input from the pushbutton sensors may be used to enact a home-key or on-off feature, control audio volume, turn the microphone on or off, etc.

FIGS. 1A and 1B show various other sensors of wearable electronic device 10. Such sensors include microphone 36, visible-light sensor 38, ultraviolet-light sensor 40, and ambient and/or skin temperature sensor 42. The microphone provides input to compute system 18 that may be used to measure the ambient sound level or receive voice commands from the wearer. Input from the visible-light sensor, ultraviolet-light sensor, and temperature sensor may be used to assess aspects of the wearer's environment—i.e., the temperature, overall lighting level, and whether the wearer is indoors or outdoors.

FIGS. 1A and 1B show a pair of contact sensor modules 44A and 44B, which contact the wearer's skin when wearable electronic device 10 is worn. The contact sensor modules may include independent or cooperating sensor elements, to provide a plurality of sensory functions. For example, the contact sensor modules may provide an electrical resistance and/or capacitance sensory function, which measures the electrical resistance and/or capacitance of the wearer's skin. Compute system 18 may use such input to assess whether or not the device is being worn, for instance. In some implementations, the sensory function may be used to determine how tightly the wearable electronic device is being worn. In the illustrated configuration, the separation between the two contact-sensor modules provides a relatively long electrical path length, for more accurate measurement of skin resistance. In some examples, a contact sensor module may also provide measurement of the wearer's skin temperature. Arranged inside contact sensor module 44B in the illustrated configuration is an optical pulse/heart rate sensor 46. This sensor may include an LED emitter and matched photodiode to detect blood flow through the capillaries in the skin and thereby provide a measurement of the wearer's pulse/heart rate.

Wearable electronic device 10 may also include motion sensing componentry, such as an accelerometer 48, gyroscope 50, and magnetometer 51. The accelerometer and gyroscope may furnish inertial and/or rotation rate data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation. The wearable electronic device may also include a global positioning system (GPS) receiver 52 for determining the wearer's geographic location and/or velocity. In some configurations, the antenna of the GPS receiver may be relatively flexible and extend into flexion regions 12.

Compute system 18, via the sensory functions described herein, is configured to acquire various forms of information about the wearer of wearable electronic device 10. Such information must be acquired and used with utmost respect for the wearer's privacy. Accordingly, the sensory functions may be enacted subject to opt-in participation of the wearer. In implementations where personal data is collected on the device and transmitted to a remote system for processing, that data may be anonymized. In other examples, personal data may be confined to the wearable electronic device, and only non-personal, summary data transmitted to the remote system.

As evident from the foregoing description, the methods and processes described herein may be tied to a sensory-and-logic system of one or more machines. Such methods and processes may be implemented as a computer-application program or service, an application-programming interface (API), a library, firmware, and/or other computer-program product. FIGS. 1A and 1B show one, non-limiting example of a sensory-and-logic system to enact the methods and processes described herein. However, these methods and processes may also be enacted on sensory-and-logic systems of other configurations and form factors, as shown schematically in FIG. 6.

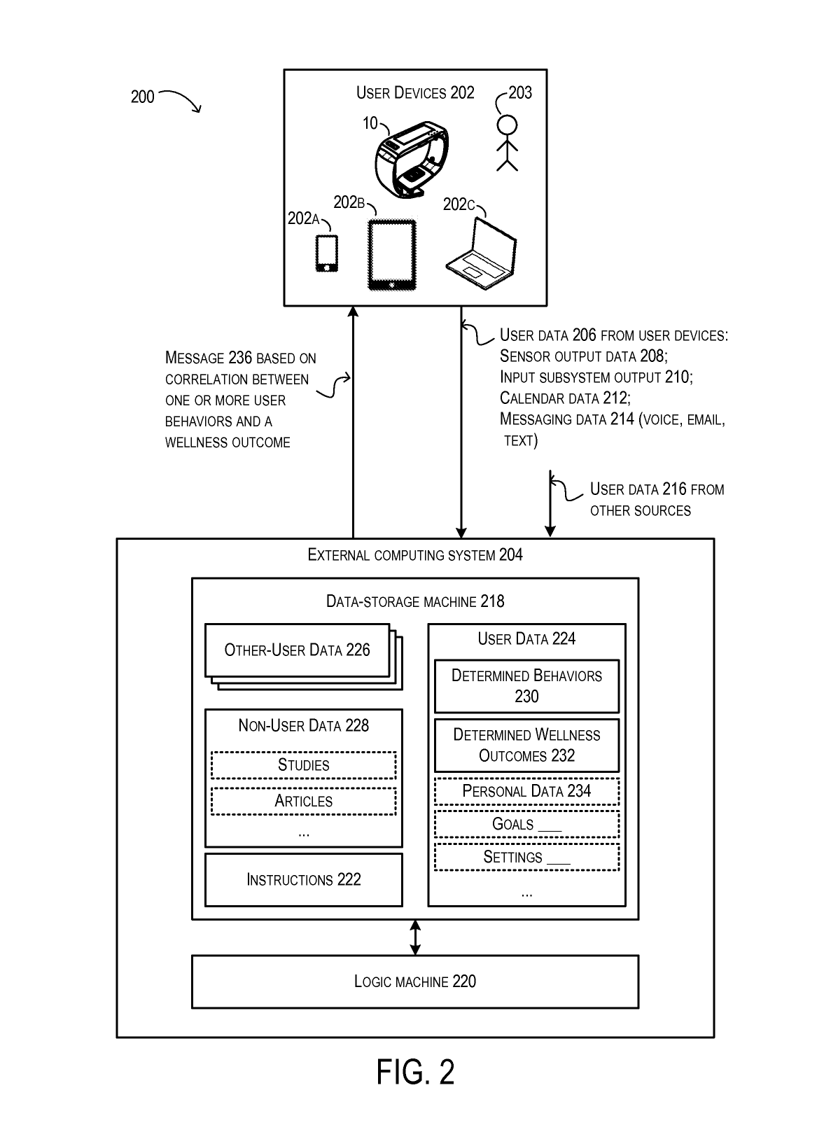

FIG. 2 schematically shows a system 200 for providing wellness-related insights to a user by, among other things, correlating user behaviors with wellness outcomes. The figure schematically shows user devices 202 associated with user 203, including wearable electronic device 10, interfacing with external computing system 204. In addition to wearable electronic device 10, the wearer 203 of device 10 may have one or more other electronic devices 202a, 202b, 202c, etc., such as a smartphone, tablet, laptop, etc.

User devices 202 may transmit various user data 206 to external computing system 204. As will be described in more detail below, user data 206 may include one or more of the following: sensor output data 208; input subsystem outputs 210 (e.g., touchscreen inputs, button presses, etc.); calendar data 212; and messaging data 214 (potentially including data relating to voice calls, text messages and email messages of user 203 and sent/received by user devices 202). Other user data 216 associated with user 203 may also be received into external computing system 204 from sources other than from user devices 202. As one non-limiting example, data 216 may include data relating to the user's social networking activity.

As indicated, external computing system 204 may include a data-storage machine 218 and a logic machine 220 (e.g., including one or more processors). Logic machine 220 may carry out the various functions described herein, for example by running executable instructions 222 held in data-storage machine 218. Data held in data-storage machine may include, among other things, user data 224 associated with user 203; data 226 associated with other users (i.e., other than user 203); and non-user data 228.

Data associated with user 203 and received into external computing system 204 (e.g., data 206 and/or 216) may be processed (e.g., via execution of instructions 222) in order to determine behaviors of the user and wellness outcomes of the user. As indicated, the determined behaviors and wellness outcomes may be stored as part of user data 224, and are indicated respectively as 230 and 232.

Sensor output data 208 may include outputs from any of the sensors discussed with reference to FIGS. 1A, 1B and 6. Specifically, the sensor output data may include one or more of: (i) a location of the user; (ii) sound at the user's location; (iii) a light characteristic at the user's location; (iv) ambient temperature at the user's location; (v) an electrical characteristic of the user's skin; (vi) motion of the user; and (vii) a heart rate of the user. As discussed in detail below, the systems and methods described herein use this data to learn about the user. Specifically, the sensor outputs are used to determine a wide range of user behaviors and wellness outcomes, which are analyzed to identify useful correlations. The correlations form the basis for insightful messages that are provided to the user. These insights can include diagnoses of past behavior and outcomes; forecasting of likely wellness outcomes; actionable suggestions and recommendations to improve wellness; etc.

Input subsystem outputs 210 can include any data/information acquired from user inputs to user devices 202. This can include, for example, button presses on wearable electronic device 10; touch screen inputs, e.g., to touch screen sensor 32 or applied to the screens of devices 202a, 202b or 202c; keyboard inputs; touch pad inputs; or other inputs.

Calendar data 212 can include any information gleaned from one or more calendars maintained by the user. As described in more detail below, the system can variously use calendar information to support user wellness. One example would be to identify for the user that meetings with certain people or in certain locations have specific effects on user stress.

A very wide range of user behaviors 230 and wellness outcomes 232 may be determined from the data received into external computing system 204. One category of determined behavior is the user's sleep behavior, which may be determined from, among other things, the sensor output data 208 from wearable electronic device 10. The following are non-limiting examples of sleep behavior that can be determined. (1) time spent sleeping; (2) sleep quality, as calculated/inferred from other sleep data; (3) sleep efficiency, as calculated/inferred from other sleep data; (4) number of times the user wakes up during the night; (5) amount of time spent in deep sleep, as opposed to light sleep, and respective percentages; (6) time spent in REM sleep, as opposed to non-REM sleep, and respective percentages; (7) time taken to fall asleep; (8) time taken to fall asleep after wakeups; (9) restlessness while sleeping; etc. In addition to determining such behavior for a given sleep session, trends and averages over time may be determined.

The motion-sensing componentry of wearable electronic device 10 will typically play a role in determining the above sleep behaviors. For example, detected user motion can be used to infer that the user has fallen asleep, has woken up, is restless, is sleeping deeply or lightly, etc. Heart rate data from optical pulse rate sensor 46 may also play a role—e.g., waking or restlessness may be inferred from an increase in heart rate. Still further, detected electrical skin characteristics or body temperature may be considered in determinations of sleeping behavior. Still further, GPS data or other location information may indicate that the user is in their bedroom. Still further, via input subsystem outputs 210, the user may for example rate a sleep session or the way they feel upon waking.

Wearable electronic device 10 and/or other user devices 202 typically will have timer functionality that is used in determining sleep behavior. For example, time-stamped motion data can be used to identify when the user went to sleep, how long a waking interval was, etc.

Sleep behavior determined from sensor outputs or otherwise may be considered a behavior that correlates with and leads to a wellness-related outcome. For example, quality sleep over time may correlate with and lead to improved exercise performance or reduced stress. In other examples, sleep may be considered alternately as itself a wellness outcome produced by behaviors (e.g., exercise behavior leading to sleep having particular characteristics, quality etc.).

Exercise and other physical activity may also be determined from sensor output data 208. As with sleep, such activity may be considered in some cases as a user behavior that correlates with and leads to a wellness outcome, and in other cases as a wellness outcome that is correlatively produced by other behavior. Motion-sensing componentry of wearable electronic device 10 typically will play a role in determining activity. For example, motion data may be used to determine. (1) number of steps taken by the user; (2) step rate; (3) speed/pace during walking, running, etc.; (4) calories burned; (5) calorie burn rate; (6) distance traveled; (7) whether the user has engaged or not engaged in a workout during a given day or other interval; etc. Calories burned may be calculated using other data, for example using the weight of the user, which may be stored as part of personal data 234. Stride length stored in personal data 234 may also assist in calculations of speed/pace and distance covered. GPS data may also be used in connection with determining characteristics of exercise and other physical activity.

Heart rate data from sensor 46 may also be used in connection with determining user behavior and wellness outcomes relating to exercise and other physical activity. One example relates to heart rate zones or intensity zones. In some cases, zone information will be stored as part of personal data 234 (e.g., as a result of user entry obtained via input subsystem outputs 210). Such data might specify a heart rate range associated with each of zones 1, 2, 3 and 4 (higher numbers corresponding to higher heart rates and intensity). This enables determination of, for example, for a given workout, time/percentage spent in each zone. Zone information may also be stored over longer intervals, for example to calculate time spent in an intensity zone over several days, weeks, etc., spanning multiple workout sessions.

Heart rate data may also be used to identify recovery, rest, fitness levels, or other physical states. Higher resting heart rate may indicate, for example, that an athlete has over-reached in training and needs to rest for a few days before resuming high-intensity exercise. The rate at which a lower heart rate is achieved after a high-intensity interval can indicate fitness level. As a further example, a lower resting heart rate can generally indicate an increase in fitness. Maximum, minimum and average heart rates may also be stored, for given workouts and over longer intervals, as part of personal data 234 and/or used in the determination of user behaviors 230 and wellness outcomes 232.

Light characteristics at the user's location can also be used in the assessment of behaviors and wellness outcomes. Ultra-violet light sensor 40 can indicate whether the user is outdoors or indoors, and may also be used as part of an assessment of the weather. This could enable, for example, an evaluation of the relative benefit of time spent outdoors vs. indoors, or of exercising outdoors vs. indoors. Time spent outside might be correlated with user stress levels or sleep quality. An embedded goal of the system might be to spend more time outside, and other behaviors can be analyzed to see whether they promote or hinder that goal.

Location information may also be used in connecting user behaviors and wellness outcomes. GPS data might indicate, for example, whether the user is at home or at work, whether the user is meeting with a particular co-worker, whether the user is spending time with family or friends (e.g., as determined from the user's address book), and other ways in which the user is spending his or her time. As mentioned above, GPS data can also support determination of speed/pace and other activity metrics.

Location information may also be derived from the user's calendar data 212. A number of correlations might be determined from this location information, for example that the user sleeps poorly the night before appointments with a particular person; sleep is affected by the number of appointments the user has; various wellness outcomes improve/increase when the user spends a certain amount of time at home or at work; or how location may affect the user in any number of ways.

Sensor output data 208 and other data can also be used to evaluate user stress. Potential stress-indicating sensor outputs may come from heart rate sensor 46 or contact sensor modules 44A/44B, for example. Stress might also be inferred from other behaviors, such as reduced sleep. In addition, the user might explicitly identify a particular event or situation as being stressful, though a voice command, touchscreen input or other mechanism. Regardless of how it is determined, stress may be considered as a behavior correlatively producing a wellness outcome, e.g., stress levels leading to reduced exercise performance. On the other hand, stress may be considered as a wellness outcome correlatively produced by behavior, e.g., quality sleep leading to reduced stress levels.

Regardless of the particulars of determining user behaviors and wellness outcomes, the system is configured to identify correlations between the user behaviors and wellness outcomes (e.g., through execution of instructions 222). A message 236 based on an identified correlation is sent to the user, for display on wearable electronic device 10 or one of the other user devices 202 of user 203. Specifically, in some examples, the message is displayed on the display of the wearable electronic device; in other examples, the message is displayed on a display of one of the user's other devices (e.g., a smartphone). In this regard, where the user employs multiple user devices 202, it will often be desirable that the wearable electronic device 10 and other devices sync (e.g., view near-field communication), so that the devices can form a coordinated system that promotes user wellness.

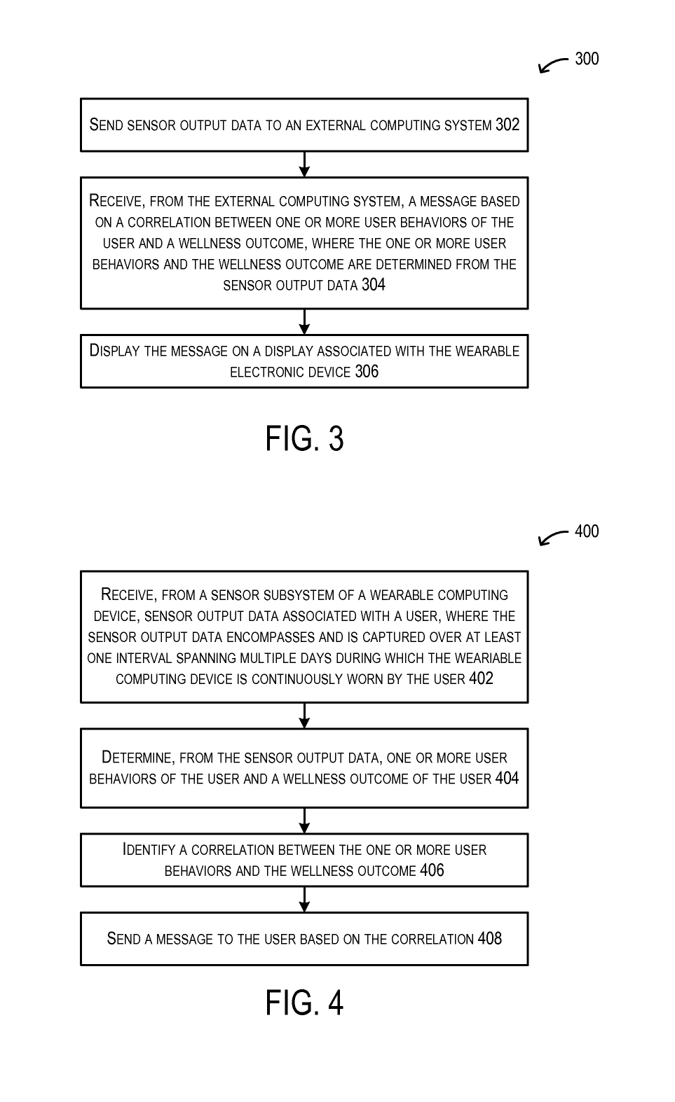

Turning now to FIGS. 3 and 4, the figures show example methods for correlating user behaviors and wellness outcomes. In FIG. 3, a method 300 is shown from the perspective of a wearable electronic device, such as wearable electronic device 10. At 302, the method includes sending sensor output data from the wearable electronic device to an external computing system, such as external computing system 204. Typically, the sensor output data encompasses and is captured over an interval spanning multiple days during which the wearable electronic device is continuously worn by the user. The transmitted sensor output data may be from one or more of the sensors described in connection with FIGS. 1A, 1B and 6. At 304, the method includes receiving, from the external computing system, a message based on a correlation between one or more user behaviors of a user (e.g., user 203) and a wellness outcome of the user. In the depicted example, both the user behaviors and the wellness outcome are determined from the sensor output data. At 306, the method includes displaying the message on a display associated with the wearable electronic device.

In FIG. 4, a method 400 for correlating user behaviors and wellness outcomes is shown from the perspective of an external computing system, such as external computing system 204. The external computing system is configured in general to receive and interpret sensor output data from a wearable electronic device, and potentially from other sources, in order to identify correlations between user behaviors and wellness outcomes. At 402, the method includes receiving, from a sensor subsystem of the wearable electronic device, sensor output data. As with method 300, the sensor output data encompasses and is captured over an interval spanning multiple days during which the wearable electronic device is continuously worn by the user. At 404 and 406, the method includes determining user behaviors and a wellness outcome from the sensor output data, and identifying a correlation between the user behaviors and the wellness outcome. At 408, a message is sent to the user based on the identified correlation.

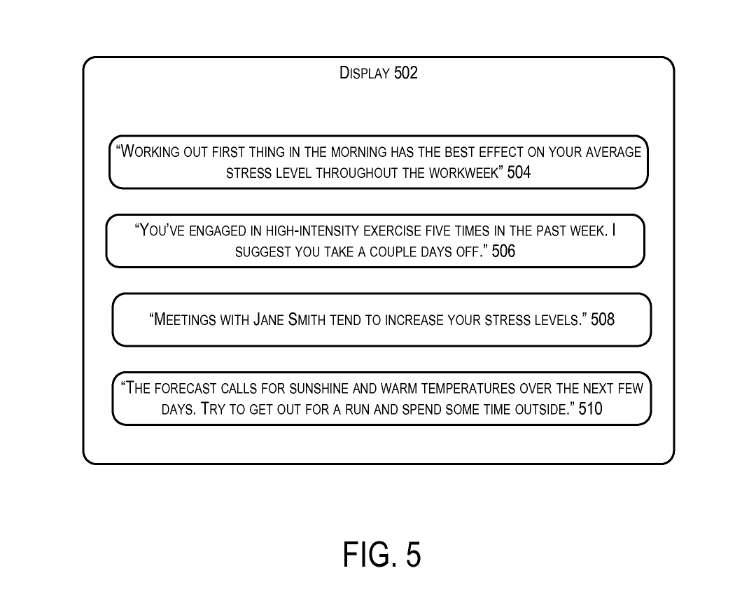

FIG. 5 depicts examples of insightful messages that may be provided to a user, and displayed on display 502, in response to identified correlations between user behaviors and wellness outcomes. Display 502 may be the display on the wearable electronic device, or it may be on another device of the user, such as the user's smartphone for example. In some cases, the message will describe the identified correlation, for example “You sleep more soundly when you exercise in the evening, as compared to exercising in the morning.” In other cases, the message includes a recommended action that correlates positively with a wellness outcome. An example of this would be: “You haven't slept much in the past week, I suggest that you exercise this evening.” In this case, the underlying correlation is between evening exercise and sleep quality, and the message is a prompt to do something that will promote the wellness outcome (improved sleep).

A first example message, shown at 504, is: “Working out first thing in the morning has the best effect on your average stress level throughout the workweek.” In this example, the observed user behavior is exercise occurring at specific times of day. This may be determined, for example, from the motion-sensing componentry of the wearable electronic device, e.g., increased step rate used to infer that exercise is occurring. Sensed heart rate may also be used to infer that exercise is occurring. The observed wellness outcome is stress level, which as discussed above, can be determined/inferred from various sensors of the wearable electronic device (e.g., heart rate, skin contact sensors, etc.).

Another example is shown at 506: “You've engaged in high-intensity exercise five times in the past week. I suggest you take a couple days off.” In this example, the underlying correlation that has been detected is an observation for the user that various beneficial effects (wellness outcomes) flow from resting after a prolonged high-intensity exercise schedule (user behavior). Such rest, for example, might result in performing at a higher level after the rest period is over. In this example, both the behavior and the wellness outcome may be determined from outputs from the sensors of wearable electronic device 10.

Yet another example is shown at 508: “Meetings with Jane Smith tend to increase your stress levels.” The user behavior in this case might be from sensor output data (e.g., GPS data providing location information showing that the user is meeting with Jane Smith), or from other data such as calendar data 212 showing that the user was meeting with Jane Smith at a particular day/time when the correlated elevated stress levels were observed.

Yet another example is shown at 510: “The forecast calls for sunshine and warm temperatures over the next few days. Try to get out for a run and spend some time outside.” The underlying correlation in this example is a connection between being outside, exercising outside, etc. (user behaviors) and positive wellness outcomes that have been correlatively observed, such as reduced stress levels, improved fitness, higher activity levels, etc.

The example above illustrates a further feature that may be implemented in connection with the systems and methods described herein. Specifically, insightful messages to the user may be timed in response to detecting a temporal opportunity associated with a recommended action. The insights are paired with contextual actions. In the above example, based on a weather forecast, the system has detected an opportunity for outside activity and has provided a timely suggestion to the user to engage in such activity. Another example would be suggesting evening exercise the evening before a day with a lot of meetings on the user's calendar. In connection with message 508, the system could provide messages suggesting stress-reducing actions as a meeting with Jane Smith approaches (the system would have knowledge of the meeting, for example, from calendar data 212).

The above examples focus primarily on scenarios in which the user behaviors and wellness outcomes are both determined from the sensor output data of wearable electronic device 10. Correlations are then generated, for example via processing occurring on another device, and messages are sent based on the correlations. This arrangement enables valuable and actionable insights to be generated automatically on an ongoing basis simply as a result of the user continuously wearing the device.

In some examples, behaviors and/or correlated wellness outcomes may also be determined from a user's messaging activity 214 (voice calls, emails, text messaging, messaging on social network platforms, etc.). For example, a wellness trend might be observed based on email volume or messaging with particular people. Interactions might be grouped as being with family or friends, thereby enabling correlations between those interactions and wellness-related outcomes (e.g., lower stress). These are but non-limiting examples—a wide range of insights may be made based on such messaging activity.

As indicated at 226 in FIG. 2, data associated with other users may be collected and stored. In one class of examples, this enables the system to provide the user with insights comparing the user to others. For example, the user can be informed of their fitness, activity level, performance, etc. compared to other people in their geographic area, of similar age, in their social network, etc. In some examples, ad hoc groups of users may be generated for purposes of providing comparisons or other insights. GPS data could be used, for example, to identify a group that ran a particular course on a particular day, and the user could then be provided with information about their performance relative to that ad hoc group.

As indicated at 228 in FIG. 2, non-user data 228 may also be stored in the system. Such data may include, for example, studies or articles associated with wellness. This type of information may be provided to the user in a way that supports actionable insights. For example, in response to the user's sleep declining, the user could be informed that reduced sleep can lead to craving high-fat foods, and a supporting study or article to that effect could be directed to the user. To support an actionable insight about weight loss, an infographic might be provided that shows the weight-loss benefit of journaling calorie intake.

Various assumptions may be built into the described systems and methods and used in connection with evaluating behaviors and correlated outcomes. For example, it may be assumed that sleeping a certain amount of time each night is good, getting a certain amount of exercise is good, excessive time at work is bad, time spent with friends and family is good, etc. The user may override or adjust these assumptions, and/or may otherwise set specific behavioral and wellness outcome goals. Such information may be stored, for example, as part of personal data 234 (FIG. 2).

FIG. 6 schematically shows a form-agnostic sensory-and-logic system 600 that includes a sensor suite 602 operatively coupled to a compute system 604. The compute system includes a logic machine 606 and a data-storage machine 608. The compute system is operatively coupled to a display subsystem 610, a communication subsystem 612, an input subsystem 614, and/or other components not shown in FIG. 6.

Logic machine 606 includes one or more physical devices configured to execute instructions. The logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic machine 606 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of a logic machine optionally may be distributed among two or more separate devices, which may be remotely located and/or configured for coordinated processing. Aspects of a logic machine may be virtualized and executed by remotely accessible, networked computing devices in a cloud-computing configuration.

Data-storage machine 608 includes one or more physical devices configured to hold instructions 610 executable by logic machine 606 to implement the methods and processes described herein. When such methods and processes are implemented, the state of the data-storage machine may be transformed—e.g., to hold different data. The data-storage machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The data-storage machine may include volatile, nonvolatile, dynamic, static, read/write, read-only, random-access, sequential-access, location-addressable, file-addressable, and/or content-addressable devices.

It will be appreciated that data-storage machine 608 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 606 and data-storage machine 608 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 612 may be used to present a visual representation of data held by data-storage machine 608. This visual representation may take the form of a graphical user interface (GUI). As the herein described methods and processes change the data held by the storage machine, and thus transform the state of the storage machine, the state of display subsystem 612 may likewise be transformed to visually represent changes in the underlying data. Display subsystem 612 may include one or more display subsystem devices utilizing virtually any type of technology. Such display subsystem devices may be combined with logic machine 606 and/or data-storage machine 608 in a shared enclosure, or such display subsystem devices may be peripheral display subsystem devices. Display 20 of FIGS. 1A and 1B is an example of display subsystem 610.

Communication subsystem 614 may be configured to communicatively couple compute system 604 to one or more other computing devices. The communication subsystem may include wired and/or wireless communication devices compatible with one or more different communication protocols. As non-limiting examples, the communication subsystem may be configured for communication via a wireless telephone network, a local- or wide-area network, and/or the Internet. Communication suite 24 of FIGS. 1A and 1B is an example of communication subsystem 614.

Input subsystem 616 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. Touch screen sensor 32 and push buttons 34 of FIGS. 1A and 1B are examples of input subsystem 616.

Sensor subsystem 602 may include one or more different sensors—e.g., a touch-screen sensor 618, push-button sensor 620, microphone 622, visible-light sensor 624, ultraviolet-light sensor 626, ambient-temperature sensor 628, contact sensors 630, optical pulse-rate sensor 632, accelerometer 634, gyroscope 636, magnetometer 638, and/or GPS receiver 640—as described above with reference to FIGS. 1A and 1B.

It will be understood that the configurations and approaches described herein are exemplary in nature, and that these specific implementations or examples are not to be taken in a limiting sense, because numerous variations are feasible. The specific routines or methods described herein may represent one or more processing strategies. As such, various acts shown or described may be performed in the sequence shown or described, in other sequences, in parallel, or omitted.

The subject matter of this disclosure includes all novel and non-obvious combinations and sub-combinations of the various processes, systems and configurations, and other features, functions, acts, and/or properties disclosed herein, as well as any and all equivalents thereof.

1. A system comprising:
a wearable electronic device including a sensor subsystem configured to yield sensor output data associated with a user, wherein the sensor output data is captured over at least one interval spanning multiple days during which the wearable computing device is continuously worn by the user; and
a display associated with the wearable electronic device; and
wherein the wearable electronic device is configured to send the sensor output data to an external computing system,
wherein the system is configured to receive from the external computing system a message based on a correlation between one or more user behaviors of the user and a wellness outcome of the user, the one or more user behaviors and the wellness outcome both being determined from the sensor output data, and
wherein the display is configured to display the message.

2. The system of claim 1, where the sensor output data includes one or more of the following:
(i) a location of the user;
(ii) sound at the user's location;
(iii) a light characteristic at the user's location;
(iv) ambient temperature at the user's location;
(v) an electrical characteristic of the user's skin;
(vi) motion of the user; and
(vii) a heart rate of the user.

3. The system of claim 1, where the display is on the wearable electronic device.

4. The system of claim 1, where the display is on another electronic device of the user.

5. The system of claim 1, where the message describes the correlation.

6. The system of claim 1, where the message includes a recommended user action which the correlation shows correlates positively with the wellness outcome.

7. The system of claim 6, where the message is timed in response to detecting a temporal opportunity associated with the recommended user action.

8. The system of claim 1, where the system is configured to receive from the external computing system another message based on a correlation between location information of the user and the wellness outcome.

9. The system of claim 8, where the location information of the user is determined from the sensor output data.

10. The system of claim 8, where the location information of the user is determined from calendar data associated with the user.

11. A system for correlating user behaviors with wellness outcomes, comprising:
a wearable electronic device including a sensor subsystem configured to yield sensor output data associated with a user, where the sensor output data encompasses and is captured over at least one interval spanning multiple days during which the wearable computing device is continuously worn by the user;
a display associated with the wearable electronic device; and
where (i) the wearable electronic device is configured to send the sensor output data to an external computing system, (ii) the system is configured to receive from the external computing system a message based on a correlation between more or more user behaviors of the user and a wellness outcome of the user, the one or more user behaviors and the wellness outcome being determined from the sensor output data and from location information of the user, and (iii) the display is configured to display the message.

12. The system of claim 11, where the sensor output data includes one or more of the following:
(i) a location of the user;
(ii) sound at the user's location;
(iii) a light characteristic at the user's location;
(iv) ambient temperature at the user's location;
(v) an electrical characteristic of the user's skin;
(vi) motion of the user; and
(vii) a heart rate of the user.

13. The system of claim 11, where the location information of the user is obtained from a GPS receiver of the sensor subsystem.

14. The system of claim 13, where the location information of the user is determined from calendar data associated with the user.

15. A system for correlating user behaviors with wellness outcomes, comprising:
a logic machine; and
a data-storage machine containing instructions configured, when executed by the logic machine, to
(i) receive, from a sensor subsystem of a wearable computing device, sensor output data associated with a user, where the sensor output data encompasses and is captured over at least one interval spanning multiple days during which the wearable computing device is continuously worn by the user;
(ii) determine, from the sensor output data, (a) one or more user behaviors of the user and (b) a wellness outcome of the user;
(iii) identify a correlation between the one or more user behaviors and the wellness outcome; and
(iv) send a message to the user based on the correlation.

16. The server system of claim 15, where the sensor output data associated with the user is one or more of the following:
(i) a location of the user;
(ii) sound at the user's location;
(iii) a light characteristic at the user's location;
(iv) ambient temperature at the user's location;
(v) an electrical characteristic of the user's skin;
(vi) motion of the user; and
(vii) a heart rate of the user.

17. The system of claim 15, where the message describes the correlation.

18. The system of claim 15, where the message includes a recommended user action which the correlation shows correlates positively with the wellness outcome.

19. The system of claim 18, where the message is timed in response to detecting a temporal opportunity associated with the recommended user action.

20. The system of claim 15, instructions being further configured to send another message to the user based on a correlation between location information of the user and the wellness outcome.
